(19) United States
(12) Patent Application Publication
(10) Pub. No.: US 2007/0013176 A1
(43) Pub. Date: Jan. 18, 2007

(54) Gas bag module

(75) Inventors: Holger Staudt, Grossostheim (DE); John-Oliver Derrick, Hettstadt (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive safety systems GmbH

(21) Appl. No.: 11/488,936

(22) Filed: Jul. 18, 2006

(30) Foreign Application Priority Data
Jul. 18, 2005 (DE) 20 2005 011 296.8

(51) Int. Cl. B60R 21/26; B60R 21/276

(52) U.S. Cl. 280/737; 280/736; 280/740; 280/728.2

(57) ABSTRACT

A gas bag module for a vehicle occupant restraint device has a gas generator for inflating a gas bag, at least one discharge opening which is formed in a rigid component of the gas bag module and through which gas generated by the gas generator can be discharged, and a slide element that is adjustable between a closed position in which it at least largely closes the discharge opening, and an open position in which it exposes the discharge opening. A control member for the slide element is provided, the control member having a pressure surface that can be subjected to the pressure of the gas generated by the gas generator so that, when a specific pressure is present, the control member effectuates a change in the position of the slide element.

### TECHNICAL FIELD

The present invention relates to a gas bag module for a vehicle occupant restraint device.

### BACKGROUND OF THE INVENTION

Normally speaking, the gas bag of a gas bag module should be inflated as quickly as possible with gas generated by a gas generator. In certain cases, however, it is desirable not to inflate the gas bag with the entire volume of gas available but rather, to put it in more general terms, to discharge gas, which is why the gas bag module is provided with discharge openings that are exposed so that the pressure in the gas bag can be limited.

The literature describes numerous solution possibilities that have the aim of regulating the internal pressure and thus the restraining effect of the gas bag as a function of the load in case of an accident. Thus, for example, gas bag modules are known in which a discharge opening in a housing of the module is covered in the closed state by a slide or the like that can be moved in order to expose the opening. Such slides are moved, for example, magnetically or by means of an electric motor and are consequently very complex and relatively slow.

U.S. Pat. No. 5,695,214 discloses a gas bag module in which several discharge openings arranged in the module housing are exposed in that a flap-like closure element is moved from a closed position into an open position. Here, the closure element in the closed position is securely joined to the module housing by means of an explosive bolt. A plurality of sensors is provided that determine the position of a vehicle occupant, his/her size, the severity of the collision as well as the ambient temperature. When the gas bag is deployed, the explosive bolt is activated as a function of these parameters in order to expose the discharge openings. However, such a system with electronic sensors is relatively complex and thus expensive. Another drawback is the fact that installation space has to be made available in the module housing for the flap and for the explosive bolt.

In contrast, the invention provides a gas bag module in which additional discharge openings in the module are initially covered and are exposed as needed, and which is characterized by its simple construction and low production costs.

### BRIEF SUMMARY OF THE INVENTION

This is achieved in a gas bag module for a vehicle occupant restraint device having a gas generator for inflating a gas bag, at least one discharge opening which is formed in a rigid component of the gas bag module and through which gas generated by the gas generator can be discharged, and a slide element that is adjustable between a closed position in which it at least largely closes the discharge opening, and an open position in which it exposes the discharge opening. Furthermore, the gas bag module comprises a control member for the slide element having a pressure surface that can be subjected to the pressure of the gas generated by the gas generator so that, when a specific pressure is present, the control member effectuates a change in the position of the slide element. Consequently, in the configuration according to the invention, exclusively the pressure of the gas generated by the gas generator is made use of in order to expose a discharge opening formed in a rigid component of the module. In this context, the rigid component is to be understood as being an inflexible component of the module, that is to say, for example, a generator support or a gas bag holding plate. The gas exerts pressure onto the control member (or onto its pressure surface) which, in turn, is operatively connected to the slide element in such a way that any movement of the control member caused by the gas pressure also brings about a change in the position of the slide element. In particular, the slide element is initially in its closed position and, once the pressure surface has been sufficiently subjected to pressure, it is moved into its open position. (Of course, the opposite would also be possible, namely, that the discharge opening is in the open state at the beginning of the gas bag deployment and is only closed as the need arises.)

Therefore, the configuration according to the invention makes use of the pressure-dependent exposing of the discharge opening to ensure in a simple manner that the pressure in the interior of the gas bag does not exceed a specific, predefined value. This ensures, for instance, that the gas bag, irrespective of the ambient temperature, always has a sufficient restraining effect and, at the same time, that the gas bag is not too hard. This is especially important in case of high temperatures at which the pressure of the generated gas is likewise higher. Moreover, the gas bag module according to the invention is also characterized by a reliable and inexpensive configuration of the opening mechanism.

According to a first embodiment of the invention, when the pressure surface is subjected to compressed gas, the control member engages with the slide element and moves it between the closed position and the open position. Of course, it is equally well possible for the control member to engage with the slide element already in the non-actuated state.

The slide element is preferably a linearly movable plate that is arranged in an appropriate guide on the rigid component of the gas bag module.

The control member advantageously has a control edge that slides along an edge of the slide element when it is subjected to compressed gas. In particular, the control edge encloses an acute angle with the direction of movement of the control member as well as with the direction of movement of the slide element. This results in a simple mechanism for moving the slide element when the control member is actuated.

According to a second embodiment of the invention, the control member can be moved between a locking position in which it affixes the slide element relative to the rigid component, and a releasing position in which the slide element can change its position. Hence, the control member is configured here as a kind of releasing mechanism that, when actuated, releases the previously affixed slide element so that it can move out of the closed position into the open position.

Advantageously, a spring element is provided that urges the slide element into the open position. In this manner, it is achieved that, after the slide element has been released by the control member, the slide element is reliably moved into the open position.

The slide element can be a rotatably mounted plate or a linearly movable plate. In both cases, the plate is attached to the rigid component of the gas bag module in such a way that it first (at least largely) closes the discharge opening and, after being released by the control member, executes a rotational movement or a linear movement by means of which it exposes the discharge opening.

Preferably, the control member has a locking pin that, in the non-actuated state, engages into a recess of the slide element, as a result of which the slide element is affixed relative to the rigid component of the gas bag module. When the control member is subjected to pressure, the locking pin leaves the recess of the slide element, thus releasing it.

The control member can have a spring that holds the locking pin engaged with the recess. When the pressure surface of the control member is then subjected to a sufficiently high pressure to compensate for the force exerted by the spring, the locking pin leaves the recess and the slide element can move.

According to a preferred embodiment, the gas generator is a multi-stage gas generator. In this case, precautions can be taken to ensure that the control member is only subjected to compressed gas from the gas generator when a later stage, for instance, the second stage of the gas generator, is ignited. As a result, the gas bag initially deploys quickly while the discharge opening is closed and, when the later stage is ignited, the discharge opening is exposed in order to provide the vehicle occupant with a softer gas bag.

When the control member is subjected to compressed gas, it is preferably moved in a direction that is perpendicular to the direction of movement of the slide element. Consequently, when the control member is subjected to compressed gas, it is preferably moved downwards in the vertical direction, thus horizontally moving a slide element arranged below the gas generator on the rigid component of the gas bag module in order to expose the discharge opening formed in the rigid component. This translates into a particularly space-saving configuration.

### BRIEF DESCRIPTION OF THE DRAWINGS

FIG. 1 shows a half-sectional view of a gas bag module according to a first embodiment of the invention, with a slide element in the closed position;

FIG. 2 shows a half-sectional view of the gas bag module of FIG. 1, but with the slide element in the open position;

FIG. 3 shows a half-sectional view of a gas bag module according to a second embodiment of the invention, with the slide element in the closed position; and

FIG. 4 shows a top view of the slide element of the gas bag module of FIG. 3.

### DETAILED DESCRIPTION OF THE PREFERRED EMBODIMENTS

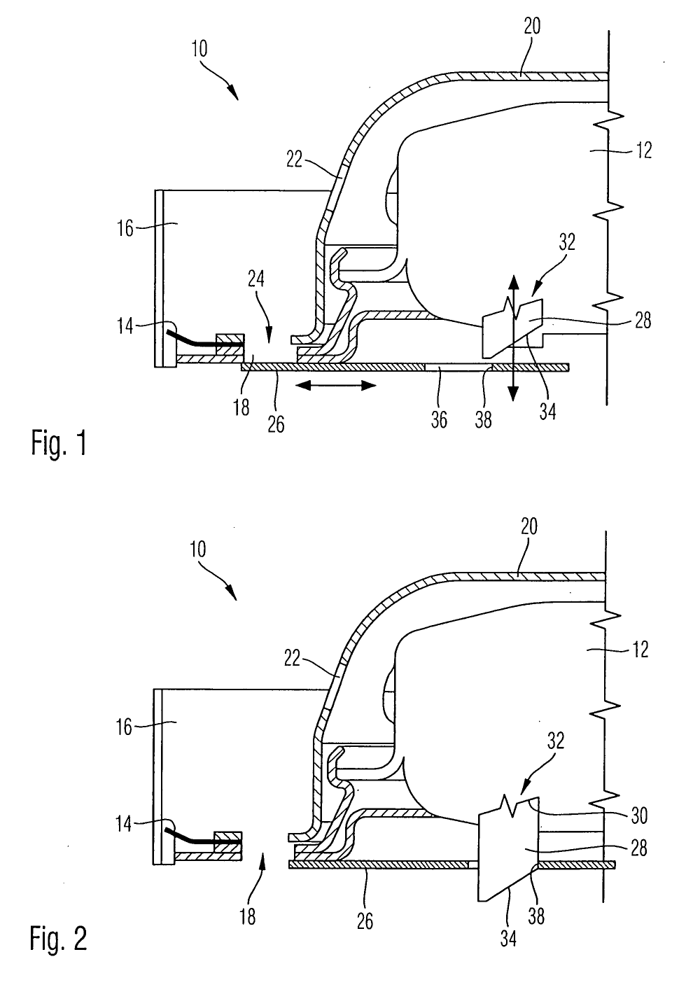

FIG. 1 shows a gas bag module 10 that is intended particularly for use as a driver-side gas bag module, although it is not limited to this. The gas bag module 10 has a gas generator 12 and a gas bag 14 (only partially indicated in the figure) and, in the non-deployed state, it is delimited by a covering cap (not shown) facing the vehicle occupant. A discharge opening 18 is formed in a rigid component of the gas bag module 10 in the form of a generator support 16. A cage 20 surrounding the gas generator 12 and concurrently serving as a diffuser with openings 22 and as a holding plate for the gas bag 14 has an opening 24 that corresponds to the discharge opening 18 in its lower part that secures the gas bag 14. In this area, the gas bag 14 likewise has an opening, or else the gas bag 14 is attached to the module laterally away from the discharge opening 18 by means of the cage 20, as is shown in FIG. 1.

In the state shown in FIG. 1, the discharge opening 18 is closed by a slide element 26 in the form of a linearly movable plate that is arranged movably on the underside of the generator support 16. Moreover, a control member 28 is provided that, at its upper end as shown in the figure, has a pressure surface 30 that, in the position shown in FIG. 1, protrudes into the interior of the generator housing through an opening 32 in the housing of the gas generator 12. At its lower end in the figure, the control member 28 has a control edge 34 that encloses an acute angle of approximately 55° to 60° with the vertical, that is to say, the direction of movement of the control member 28. In the slide element 26, a recess 36 is provided that is delimited on the right-hand side in the figure by an edge 38 that is situated below the control edge 34.

In case of activation of the gas bag module 10, the discharge opening 18, as shown in FIG. 1, is initially closed by the slide element 26. Gases flowing out of the gas generator 12 exert pressure on the pressure surface 30 of the control member 28. If this pressure exceeds a predetermined value, then the control member 28 is moved downwards in FIG. 1, as a result of which the control edge 34 engages with the slide element 26 or with its edge 38. Consequently, during the downwards sliding movement of the control member 28, the slide element 26 is moved towards the right in the figures according to the principle of an “inclined plane” and exposes the discharge opening 18 (see FIG. 2). Therefore, due to the slanted control edge 34, the vertical movement of the control member 28 is converted into a horizontal movement of the slide element 26. The discharge opening 18 is now free, which is why the gases generated by the gas generator 12 can partially escape into the environment. As a result, a softer gas bag 14 is provided for the vehicle occupant.

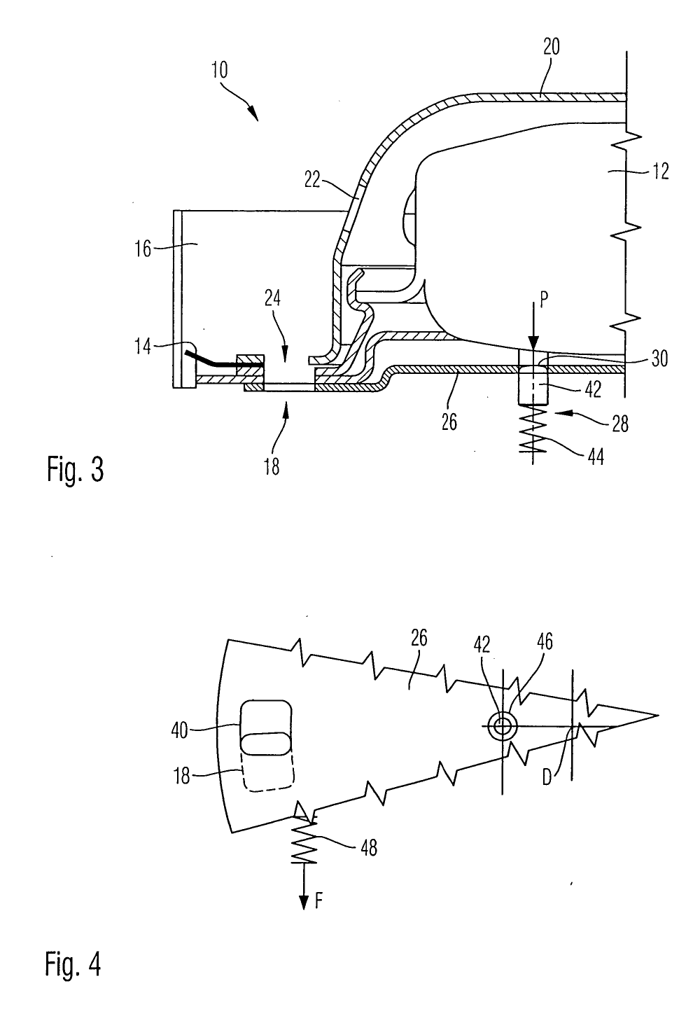

FIGS. 3 and 4 show another embodiment of the gas bag module 10 according to the invention; the same components have the same reference numerals and only the differences from the first embodiment will be discussed below.

The slide element 26 according to the second embodiment is configured as a rotary valve element, i.e. as a plate that is rotatably mounted in point D on the generator support 16. As an alternative, a linearly movable plate, as described with reference to FIGS. 1 and 2, can likewise be employed. The slide element 26 has an opening 40 that can be made to coincide with the discharge opening 18. The control member 28 comprises a locking pin 42 as well as a spring 44 that holds the locking pin 42 so as to engage with a recess 46 in the slide element 26 (see FIG. 3).

Another spring 48 is provided that is supported, for example, on the generator support 16 and that urges the slide element 26 into its open position. This spring 48 can be a helical spring, a coiled torsion spring or, as shown in FIG. 4, a tension spring.

In the initial situation shown in FIG. 3 immediately after the ignition of the gas generator 12, the discharge opening 18 is at first mainly closed by the slide element 26, i.e. the two openings 40, 18 overlap to a small extent, as a result of which a certain partial area of the discharge opening is exposed already in the initial state. As an alternative, the discharge opening 18 can be completely closed in the initial situation by the opening 40 in the slide element 26 not coinciding at all with the discharge opening 18.

Now when the top of the locking pin 42, which again represents a pressure surface 30, is subjected to a specific pressure generated by the gas generator 12, the locking pin 42 is pressed downwards against the tension of the spring 44, thus freeing the recess 46 in the slide element 26. The slide element 26, which is now no longer affixed relative to the generator support 16, rotates counterclockwise because of the tensile force F exerted by the pre-tensioned spring 48 (see FIG. 4), so that the opening 40 of the slide element 26 comes to lie precisely underneath the discharge opening 18 in the generator support 16. As a result, the discharge opening 18 is (completely) exposed and gases can flow out.

In the embodiment shown in FIGS. 3 and 4, the control member 28 is thus configured as a locking and releasing mechanism. Here, too, the direction of movement of the control member 28 is perpendicular to the direction of movement of the slide element 26.

In all of the embodiments described, the gas generator 12 can be a two-stage or a multi-stage gas generator, the control member 28 then being arranged in such a way that it is only subjected to compressed gas when the second (or a later) stage of the gas generator 12 is ignited. As a result, the gas bag 14 deploys quickly at first while the discharge opening 18 is closed and, when the later stage is ignited, the discharge opening 18 is exposed in order to provide the vehicle occupant with a softer gas bag.

1. A gas bag module for a vehicle occupant restraint device, comprising
a gas generator (12) for inflating a gas bag (14),
at least one discharge opening (18) which is formed in a rigid component of the gas bag module (10) and through which gas generated by the gas generator (12) can be discharged,
a slide element (26) that is adjustable between a closed position in which it at least largely closes the discharge opening (18), and an open position in which it exposes the discharge opening (18), and
a control member (28) for the slide element (26) having a pressure surface (30) that can be subjected to the pressure of the gas generated by the gas generator (12) so that, when a specific pressure is present, the control member (28) effectuates a change in the position of the slide element (26).

2. The gas bag module according to claim 1, wherein, when the pressure surface (30) is subjected to compressed gas, the control member (28) engages with the slide element (26) and moves it between the closed position and the open position.

3. The gas bag module according to claim 1, wherein the slide element (26) is a linearly movable plate.

4. The gas bag module according to claim 1, wherein the control member (28) has a control edge (34) that slides along an edge (38) of the slide element (26) when it is subjected to compressed gas.

5. The gas bag module according to claim 4, wherein the control edge (34) encloses an acute angle with the direction of movement of the control member (28) as well as with the direction of movement of the slide element (26).

6. The gas bag module according to claim 1, wherein the control member (28) can be moved between a locking position in which it affixes the slide element (26) relative to the rigid component, and a releasing position in which the slide element (26) can change its position.

7. The gas bag module according to claim 6, wherein a spring element (48) is provided that urges the slide element (26) into the open position.

8. The gas bag module according to claim 6, wherein the slide element (26) is a rotatably mounted plate.

9. The gas bag module according to claim 6, wherein the slide element (26) is a linearly movable plate.

10. The gas bag module according to claim 6, wherein the control member (28) has a locking pin (42) that, in a non-actuated state, engages into a recess (46) of the slide element (26).

11. The gas bag module according to claim 10, wherein the control member (28) has a spring (44) that holds the locking pin (42) engaged with the recess (46).

12. The gas bag module according to claim 1, wherein the gas generator (12) is a multi-stage gas generator.

13. The gas bag module according to claim 1, wherein, when the control member (28) is subjected to compressed gas, it is moved in a direction that is perpendicular to the direction of movement of the slide element (26).
